(19) United States
(12) Patent Application Publication
(10) Pub. No.: US 2005/0132021 A1
(43) Pub. Date: Jun. 16, 2005

(54) Method for playing multimedia content

(76) Inventor: Marlon Mehr, Torrance, CA (US)

Correspondence Address: COUDERT BROTHERS LLP, 333 SOUTH HOPE STREET, 23RD FLOOR, LOS ANGELES, CA, 90071, US

(21) Appl. No.: 10/966,347

(22) Filed: Oct. 14, 2004

Related U.S. Application Data
(60) Provisional application No. 60/511,828, filed on Oct. 15, 2003.

(51) Int. Cl. G06F 15/16

(52) U.S. Cl. 709/217; 709/222

(57) ABSTRACT

The invention is a method for playing multimedia content by a single HTML browser interface that can display stream content such as Intranet, Internet, ROM, DVD data, etc. within a single or multiple windowed interface. Since the playback of multimedia relies on one or more decoders that have to be present on the operating system, the decoder(s) can be purchased if not present. Alternately, the decoder(s) and newer components and executables can be downloaded via the Internet, from a DVD-ROM title by purchasing an unlocked code, or from a local storage medium. Functionality of the interface is not limited to any platform and can be used on a PC, Macintosh, or UNIX based system. The interface can interact with multimedia by triggering one form of content to another that can be displayed in a new or existing browser window, and can be used as a stand alone DVD player.

### CROSS-REFERENCE TO RELATED APPLICATION(S)

The present application claims the benefit of priority from pending U.S. Provisional Patent Application No. 60/511,828, entitled “A Method for Playing Multimedia Content”, filed on Oct. 15, 2003, which is herein incorporated by reference in its entirety.

### BACKGROUND OF THE INVENTION

1. Field of the Invention

The present invention relates to the field of multimedia, and in particular to a method for playing multimedia content.

Portions of the disclosure of this patent document contain material that are subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

Combining DVD-ROM and WEB based technology has spawned different ways for the end-user to receive content in various forms. In addition, DVD content can be in a number of formats such as c-DVD, CD, MPEG, Flash, or other formats. It is desired to provide a way of playing DVD's on a computer so that all of the various media can be accessed in a single interface. In addition, there may be features and content that are not accessible by a stand alone DVD player but are accessible on a computer. Many prior art attempts to solve these problems suffer from disadvantages.

One disadvantage is the modality of the prior art. For example, if there is Flash content included on a DVD, the prior art may require a separate application to be launched with its own dedicated window and even separate interface. It is desired to have a single interface with content of all types being provided in a single view area or window. In addition, it may be desired to have the appearance of a single application accessing and playing different media, even when different applications are engaged in the background to accomplish this.

### SUMMARY OF THE INVENTION

The present invention is a method for playing multimedia content. According to one embodiment of the present invention, a single HTML browser interface is used to play the multimedia. According to another embodiment of the present invention, the visual representation of the interface can be altered via a method to create a personalized “skin” on a per user basis. According to another embodiment of the present invention, the HTML browser interface can display various stream content such as Intranet, Internet, ROM, DVD data, CD, c-DVD, MPEG-2, or other media source within a single or multiple windowed interface. According to another embodiment of the present invention, since the playback of MPEG-2 based DVD content has to rely on one or more decoders that have to be present on the operating system, the decoder(s) can be purchased along with the present invention if not already present on the operating system. Alternately, the decoders and newer backwards compatible components and executables can be either downloaded via the Internet or from a newer DVD-ROM title. According to another embodiment of the present invention, functionality is not limited to a particular platform and can be used on a PC, Macintosh, or UNIX based system. According to another embodiment of the present invention, the browser interface can interact with various multimedia content by offering a method for one form of content to trigger another form of content to display in a new or existing browser based window. According to another embodiment of the present invention, the DVD-ROM navigation and DVD playback navigation may be tracked by using different methods.

According to another embodiment of the present invention, the browser interface can be used as a stand alone MPEG-2® or Dolby® Digital AC-3 decoder (DVD player) when the operating system contains the necessary decoders. If the operating system does not contain the necessary decoders, the end-user can purchase the necessary decoders off an Internet webpage. In an alternative embodiment, the end-user may obtain the necessary decoders directly from the DVD disc after purchasing an unlock code. In this embodiment, the additional decoders needed to play the multimedia content are stored on the DVD disc in a locked or encrypted form. After the end-user enters the unlock code, the decoders may be downloaded from the DVD disc.

According to another embodiment of the present invention, the DVD-ROM navigation and DVD playback navigation may be tracked by observing the title and chapter changes. Alternatively, in another embodiment, the navigation may be tracked by recording all of the end-user's key strokes and/or player control movements.

### BRIEF DESCRIPTION OF THE DRAWINGS

These and other features, aspects and advantages of the present invention will become better understood with regard to the following description, appended claims and accompanying drawings where:

FIG. 1 is a flowchart of the setup to play multimedia content, according to one embodiment of the present invention.

FIG. 2 is a flowchart of the method to play multimedia content, according to another embodiment of the present invention.

FIG. 3 is a definition of functions needed to play the multimedia content, according to another embodiment of the present invention.

FIG. 4 is a flowchart illustrating the flow of processes, according to another embodiment of the present invention.

FIG. 5 is a flowchart illustrating one ability of the present invention to assist a user to obtain decoder(s) if they are not already present on the operating system, according to one embodiment of the present invention.

FIG. 6 is a flowchart illustrating another ability of the present invention to assist a user to obtain decoder(s) if they are not already present on the operating system, according to another embodiment.

### DETAILED DESCRIPTION OF THE INVENTION

The embodiments of the present invention are directed to a method for playing multimedia content. In the following description, numerous specific details are set forth to provide a more thorough description of embodiments of the invention. It will be apparent, however, to one skilled in the art, that the embodiments of the present invention may be practiced without these specific details. In other instances, well known features have not been described in detail so as not to obscure the invention.

Setup

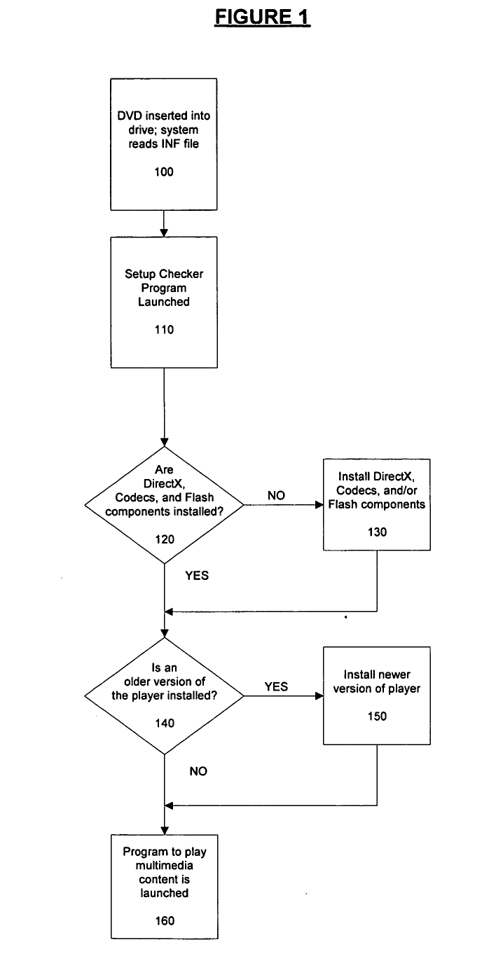

FIG. 1 is a flowchart that illustrates the setup to play the multimedia content. At block 100 the multimedia content, which can be in the form of a DVD, is inserted into the appropriate drive of a computer or DVD player. The system then reads the INF file, which is the auto-start file for a CD-ROM, and launches a setup checker program (block 110). The setup checker program, at block 120, then checks the Registry for DirectX, Codecs, and Flash executable components. If some or all of these components are not installed, they are installed at block 130.

However, if the registry checks of block 120 are all passed, at block 140, the setup checker program checks for an older version of the player than the one currently bundled with the inserted DVD. If the setup checker program detects that the inserted DVD contains a newer version of the player, at block 150, any newer required player components (e.g., skins, help pages) are installed. Alternatively, if the setup checker program determines that the new version is already present on the system, at block 160, the program to play multimedia content is launched.

In an alternative embodiment, the setup checker program could consist of two separate executables rather than only one executable as depicted in FIG. 1. In this embodiment, one executable would be used to check the Registry for components and the other executable would check the player version.

Operation

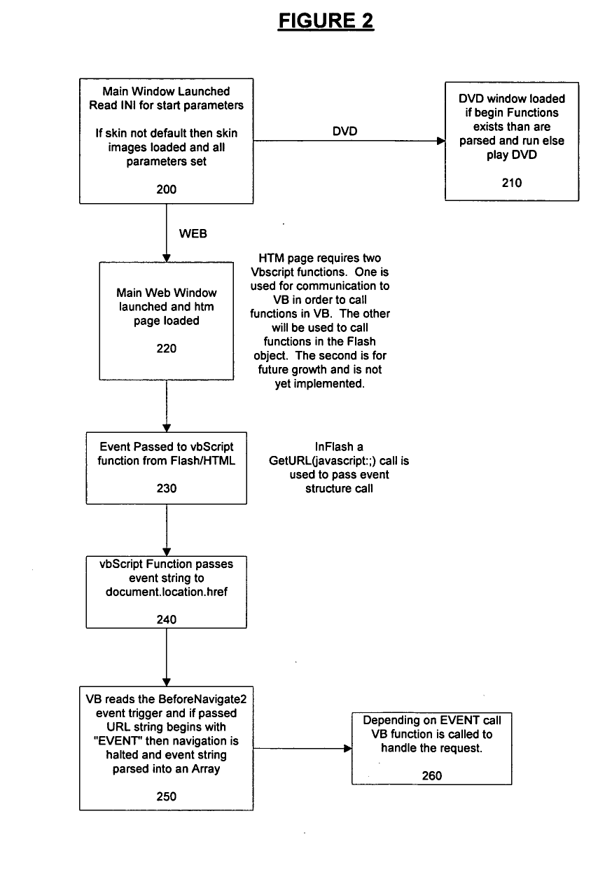

FIG. 2 is a flowchart that illustrates a method to play multimedia content. At block 200, a main window is launched and the INI is read for the starting parameters. At this step if the user does not have a default skin setup, then the skin images are loaded and all the parameters set. In other embodiments, various control technologies, such as ActiveX or Dynamic Link Library (DLL), may be used for the skinning solution. If the multimedia content is a DVD, then at block 210 a DVD window is loaded if the begin functions exist. The functions are parsed and run, else the DVD is played. If, on the other hand, the multimedia content is being downloaded via the Internet (or Web), then at block 220 a Main Web window is launched and the htm page is loaded. It should be noted here that the htm page requires two functions to be loaded. The first is used for communicating with Visual Basic® (VB) to call functions in VB, and the other is used to call functions in the Flash object. Next, at block 230, the event is passed from the Flash or HTML to the vbScript. Next, at block 240, the vbScript function passes the event string to document.location.href. Next, at block 250, the VB reads the BeforeNavigate2 event trigger. If the passed URL string begins with “EVENT”, then the navigation is halted and the event string is parsed into an array. Finally, at block 260, a VB function is called to handle the request depending on the “EVENT”.

According to another embodiment of the present invention, the DVD-ROM navigation and DVD playback navigation may be tracked by various methods. In one embodiment, the navigation may be tracked by observing the title and chapter changes. Alternatively, in another embodiment, the navigation may be tracked by recording all of the end-user's key strokes and/or player control movements.

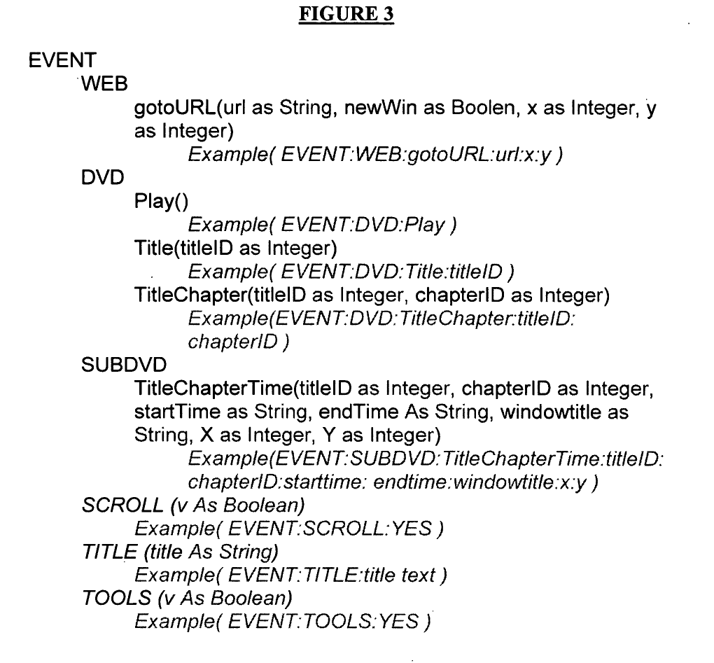

FIG. 3 illustrates a definition of EVENTs used by the invention and include WEB (accessing a URL), PLAY, TITLE, TITLECHAPTER and other DVD related events.

Flow of Process

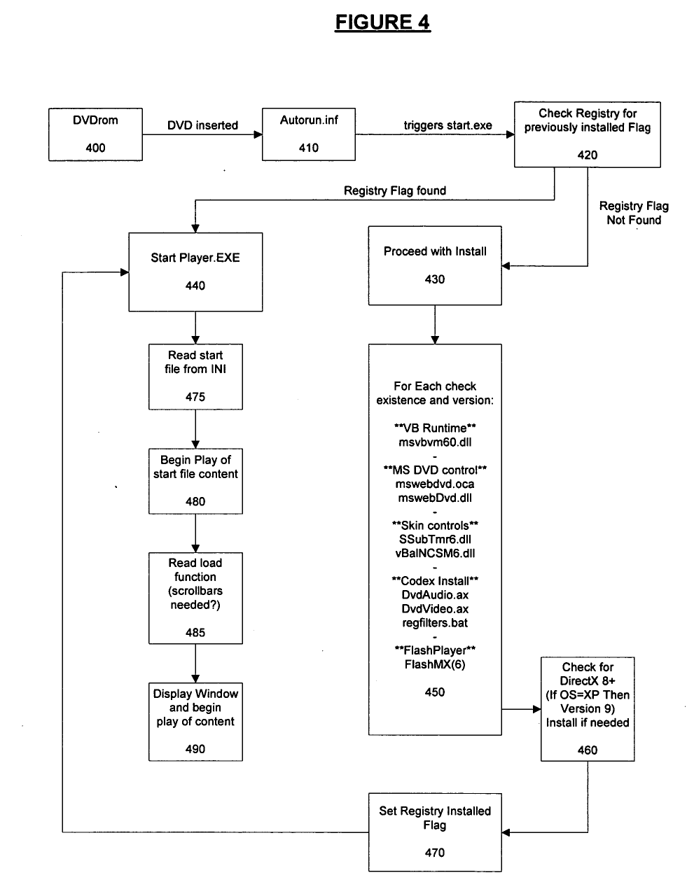

FIG. 4 is a flowchart that illustrates the flow of processes, according to another embodiment of the present invention. Block 400 shows a representation of a DVD player or DVD-ROM. When a DVD is inserted into the player or ROM, the Autorun.inf file which is the auto-start file is initiated at block 410. The file at block 410 triggers the start.exe program that checks the Registry for a previously installed flag at block 420. If the Registry flag is not found, then at block 430 installation begins. Next, at block 450, various programs are run to check the existence and version of such items as VB Runtime, MS DVD Control, Skin Controls, Codecs Install, and Flash Player. Next, at block 460, a check is made for the DirectX version. For example, if the operating system is Windows® XP®, then a newer version, say Version 9 is needed and is installed if needed. Next, at block 470, the Registry installed flag is set.

If at block 420 the Registry flag is found, or after block 470, the player.exe program is started. Next, at block 475, the start file from INI is read. Next, at block 480, the play of start file content begins. Next, at block 485, the load function is read. Finally, at block 490, a window is displayed to the user and the multimedia content is played within that window.

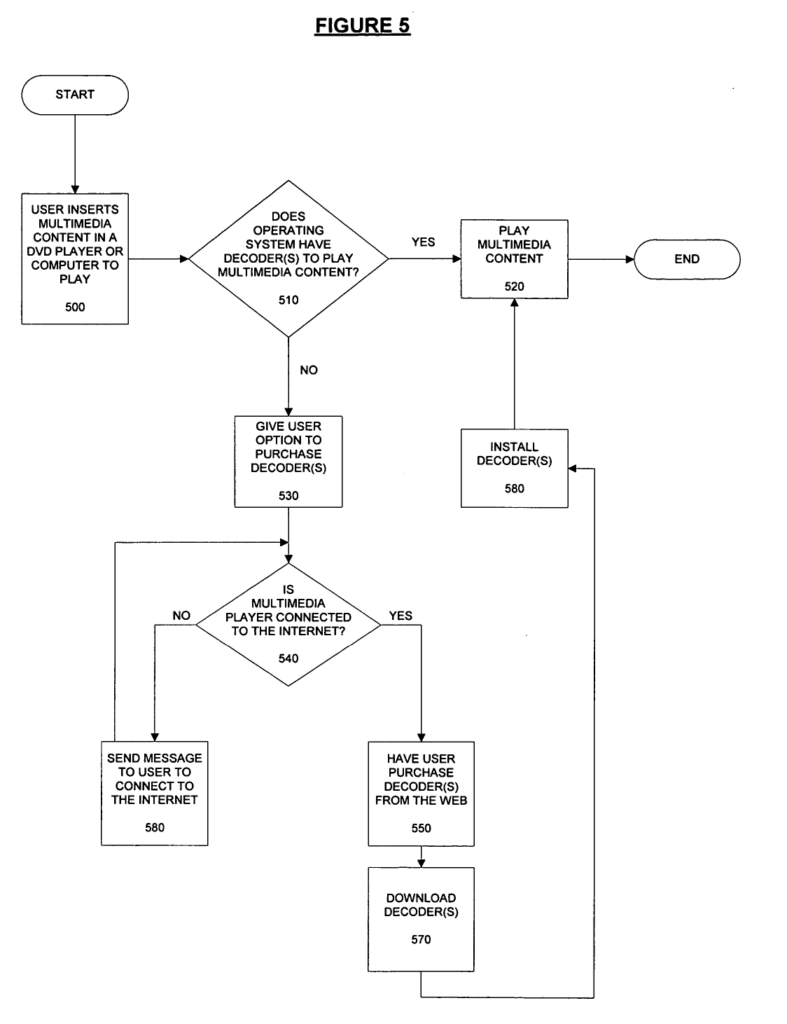

Since decoder(s) are needed to playback MPEG-2 based DVD content, the present invention offers a way for the end-user to obtain the necessary decoder(s) if they are not present on the operating system. FIG. 5 is a flowchart that illustrates this. At block 500, a user inserts a multimedia content (for example a DVD) in a DVD player or computer. At block 510, a check is made to see if the operating system has the necessary decoder(s) to play the multimedia content. If the operating system has the necessary decoder(s) (the “yes” branch), then at block 520, the multimedia content is played. If, on the other hand, the operating system does not have the necessary decoder(s) (the “no” branch), then at block 530, the user is offered the option to purchase the required decoder(s).

At block 540, a check is made to see if the multimedia player is connected to the Internet. If it is (the “yes” branch), then at block 550, the user has the option to purchase the decoder(s) from the Web. If the decoder(s) are purchased, then at block 570, the decoder(s) will be downloaded from the Web. Next, at block 580, the decoder(s) are installed and at block 520 the multimedia content is played to the user. However, if at block 540 the player is not connected to the web (the “no” branch), then at block 560, a message is sent to the user to connect to the internet.

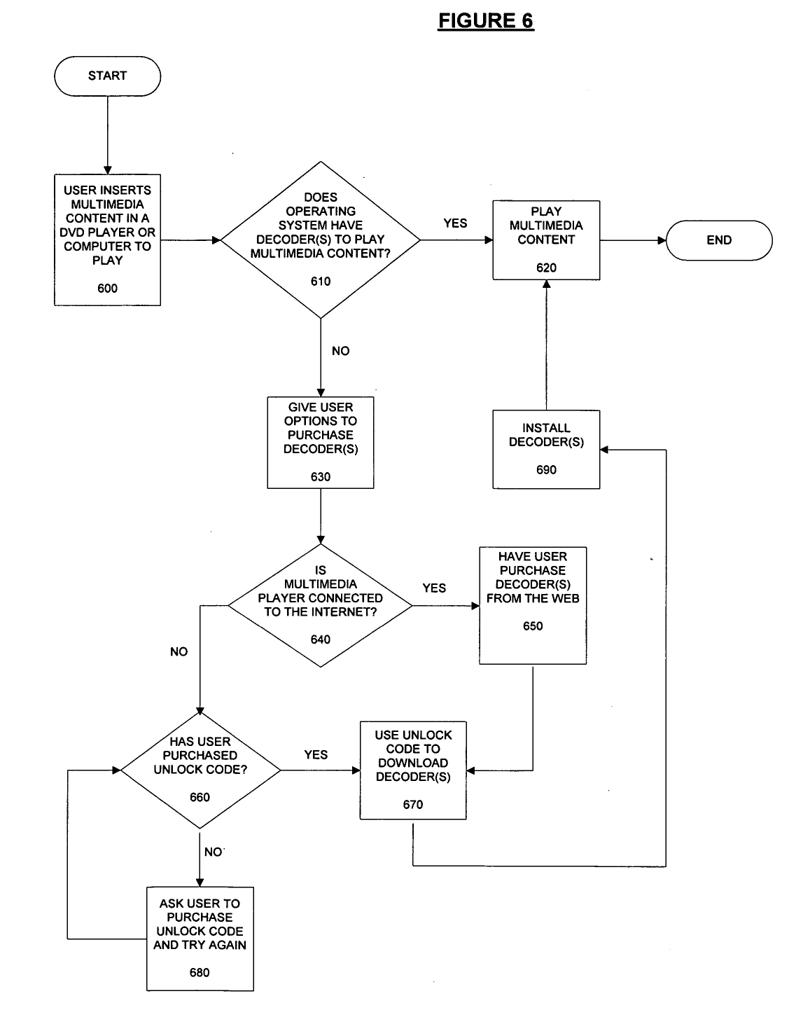

According to another embodiment, FIG. 6 is a flowchart that illustrates an alternative process for the present invention to offer the end-user the necessary decoder(s) if they are not present on the operating system. At block 600, a user inserts a multimedia content (for example a DVD) in a DVD player or computer. At block 610, a check is made to see if the operating system has the necessary decoder(s) to play the multimedia content. If the operating system has the necessary decoder(s) (the “yes” branch), then at block 620, the multimedia content is played. If, on the other hand, the operating system does not have the necessary decoder(s) (the “no” branch), then at block 630 depending on the kind of multimedia player a few options are offered to the user.

At block 640, a check is made to see if the multimedia player is connected to the Internet. If it is (the “yes” branch), then at block 650, the user has the option to purchase the decoder(s) from the Web. If the decoder(s) are purchased, then at block 670, the unlock code is used to download the decoder(s) from the Web. Next, at block 690, the decoder(s) are installed and at block 620 the multimedia content is played to the user.

If at block 640 the player is not connected to the web (the “no” branch), then a check is made at block 660 to see if the user has purchased the unlock code for the decoder(s). If the user has purchased the unlock code (the “yes” branch), then at block 670 the unlock code is used to download the decoder(s) from the multimedia and at block 690 the decoder(s) are installed. Finally, at block 620, the multimedia content is played to the user. If, on the other hand, the user has not purchased the unlock code (the “no” branch from block 660), then at block 680 the user is asked to purchase the unlock code and try again.

Thus, a method for playing multimedia content is described in conjunction with one or more specific embodiments. The invention is defined by the following claims and their full scope of equivalents.

1. A method for playing multimedia content comprising:
inspecting a media content file;
identifying programs needed to play the content file;
determining if the programs are available;
playing the content file when the programs are available.

2. The method of claim 1 comprising installing one or more needed programs when one or more needed programs is not available.

3. The method of claim 2 where the needed programs comprises codecs.

4. The method of claim 3 where the content file is played in a browser.

5. The method of claim 4 where the browser accesses needed programs from the internet.

6. The method of claim 4 where the browser accesses needed programs locally.

7. The method of claim 4 where needed programs are stored with the media content.

8. The method of claim 7 wherein the media content file is a DVD.

9. The method of claim 5 where needed programs are purchased via the internet.

10. The method of claim 7 where unlock codes are accessed to enable the needed programs.

11. The method of claim 10 where the unlock codes are purchased.
